(19) United States
(12) Patent Application Publication
(10) Pub. No.: US 2024/0195246 A1
(43) Pub. Date: Jun. 13, 2024

(54) ROTOR WITH DIRECTIONALLY ADJUSTABLE BLADES

(71) Applicants: ADV TECH, Merignac (FR); ADV PROPULSE, Merignac (FR)

(72) Inventor: Arnaud CURUTCHET, Merignac (FR)

(21) Appl. No.: 18/554,182

(22) PCT Filed: Apr. 5, 2022
(86) PCT No.: PCT/IB2022/053156

§ 371 Date: Oct. 5, 2023

(30) Foreign Application Priority Data
Apr. 6, 2021 (FR) FR2103485

(51) Int. Cl. H02K 1/28; H02K 7/116; H02K 7/14

(52) U.S. Cl. CPC H02K 1/28; H02K 7/116; H02K 7/14; H02K 2213/09

(57) ABSTRACT

A fluidic rotor that includes a rotary structure mounted on a base and supporting a set of directionally adjustable blades capable of oscillating relative to the rotation of the rotary structure about a rotor axis, and transmission devices between a central of the rotor and each of the blades, capable of individually controlling the oscillations of the blades, each device including two pivoting elements having offset pivot axes, one of the elements having a slot and the other having a pin that engages the slot. The two pivoting elements are intermediate elements of a transmission having a set of elements engaged with each other between the central shaft and the blades.

### FIELD OF THE INVENTION

The present invention generally relates to rotors with directionally adjustable blades for various fluid applications.

### PRIOR ART

In particular, the documents WO2014006603A1, WO2016067251A1 and WO2017168359A1 disclose rotors with directionally adjustable blades, typically with a blade movement of the trochoidal type.

These rotors comprise a set of transmissions between a main axis of the rotor and satellite elements connected to the respective blades by an eccentric transmission, so that the rotation of the rotor is accompanied by an oscillating movement of the blades so as to generate energy from a moving fluid, or to propel a fluid. It is understood that the weight and form factor of the rotor can be decisive for the rotor's performance.

Also known from documents U.S. Pat. Nos. 4,383,801A and 5,324,164A are mechanisms which allow, thanks to the movements of an eccentric collective control element, to modify the maximum angular displacement of the blades during oscillation.

### SUMMARY OF THE INVENTION

The present invention aims to obtain a rotor whose weight and/or form factor, in particular in the axial dimension, can be reduced.

A secondary object of the invention is to be able to carry out by concentric commands the variation of the maximum amplitude of oscillation of the blades as well as the changes in orientation of the rotor to modify the orientation of a generated flow or to adapt to a change in orientation of a received flow.

To this end, a fluidic rotor is proposed that comprises a rotary structure mounted on a base and supporting a set of directionally adjustable blades capable of oscillating relative to the rotation of the rotary structure about a rotor axis, and a set of transmission devices between a central shaft of the rotor and each of the blades, capable of individually controlling the oscillations of said blades, each device comprising two pivoting elements having offset pivot axes, one of said elements having a slot and the other having a pin that engages the slot, the rotor being characterized in that the two pivoting elements of each transmission device are intermediate elements of an individual transmission consisting of a set of elements engaged with each other between said central shaft and the blades.

Advantageous but optional aspects of this rotor are the following:
said elements of a transmission device are toothed elements in direct engagement with one another.
the two pivot elements having offset pivot axes comprise a first intermediate element engaged with an axial element rigidly connected to the central shaft, and a second intermediate element engaged with an element constrained to rotate with a frame of the associated blade.
the pin of a transmission device is mounted directly in one of the intermediate elements.
the slot of a transmission device is provided in an element attached to* the slot of a transmission device is formed in a second one of the intermediate elements.
the rotor comprises a common device for adjusting the maximum amplitude of oscillation of the blades, this device comprising a plate able to rotate around the rotor axis and having pivots of the first or second intermediate elements of each of the transmissions, so as to vary the distance between the pivot axes of the first and second intermediate elements in the circumferential direction.
the rotor comprises, concentric about the axis of the rotor, an inner shaft constituting the central shaft of the rotor, angularly movable so as to cause a corresponding overall change in the pitch of the blades via the transmission devices, an intermediate shaft rotationally adjustable to control the angular displacement of the plate of the amplitude adjustment device, and an outer shaft belonging to the rotary structure of the rotor.
the outer shaft is rigidly connected to a hollow drum housing said plate and the transmission devices and to a wall of which the blades are pivotably mounted.
a fixed axial shaft and the rotary structure of the rotor carry inner and outer elements of a rotary machine, the element carried by the rotary structure being able to generate energy within said rotary structure under the effect of its rotation relative to the element carried by the central shaft.
the rotary machine belongs to a group comprising electric motors, electric generators, and fluid pumps.

### BRIEF DESCRIPTION OF THE DRAWINGS

Other aspects, aims and advantages of the present invention will become more apparent on reading the following detailed description of a preferred embodiment thereof, given by way of non-limiting example and with reference to the attached drawings. In the drawings:

FIG. 1 is a top-down perspective overall view of a rotor according to the invention,

FIG. 2 is an axial sectional view of the rotor, showing the kinematics of one blade in particular,

FIG. 3 is a bottom-up perspective view of a subassembly of the rotor for adjusting the maximum amplitude of oscillation of the blades,

FIG. 4 is a top-down perspective view of a part of the structure and of the elements of the kinematics of the rotor,

FIG. 5 is a top-down perspective view of only those elements involved in the kinematics of the rotor,

FIG. 6 is a plan view showing the elements of the kinematics in two different positions for adjusting the maximum amplitude of oscillation of the blades, and

FIG. 7 is a view analogous to FIG. 2, showing an improvement enabling the generating of energy within the rotary part of the rotor.

### DETAILED DESCRIPTION OF AN EMBODIMENT

In the introduction, the invention aims to allow a reduction in the form factor and/or weight of a rotor with directionally adjustable blades based on a plurality of eccentric transmissions associated respectively with the plurality of blades. A secondary object of the invention is to allow optimization of the adjustment of the pitch of the blades (maximum amplitude of oscillation relative to their “neutral” orientation).

The rotor described herein adopts the principle of the angular offset of the blades during the rotation of a rotor, as described in documents WO2014006603A1, WO2016067251A1 and WO2017168359A1 by using for example a pin/slot coupling on off-center rotating elements as described in WO2017168359A1, with a different arrangement.

More specifically, this coupling is provided as an intermediate coupling of the kinematic chain, here a gear train, going from the central shaft of the rotor to the respective blade.

Furthermore, the present description is made for a marine vehicle propulsion unit, inhabited or not, it being understood that the present invention targets all applications of a rotor with directionally adjustable blades, in particular trochoidal ones.

In the case where a pitch adjustment is implemented, it advantageously takes place by virtue of a movable support of the cassette type for the pivots of the slotted elements. The angular control of the cassette relative to the body of the rotor is carried out via a control axis which emerges in the region of the propulsion unit opposite the blades. According to one embodiment, this cassette can be controlled by means of eclectic, hydraulic or pneumatic jacks mounted between the cassette and the body of the rotor. The disadvantage of this embodiment is the need to use rotating joints to control the different jacks.

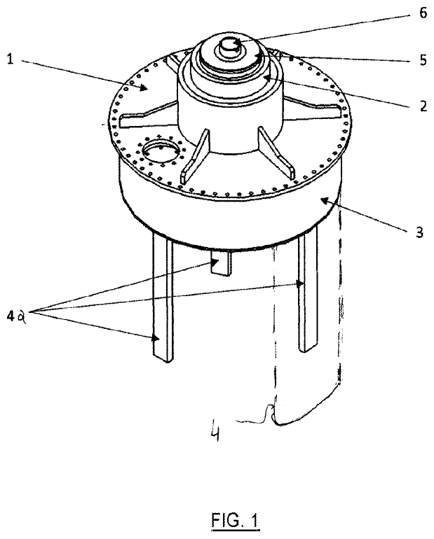

With reference to the drawings and in particular first of all in FIG. 1, a fixed or base support 1, provided to be mounted in a well in the case of a propulsion application, rotatably supports a main shaft 2 of the rotor, which is rigidly connected with a drum 3. A plurality of blades are mounted on the drum while being rotatable about a respective axis. Here only the three frames 4a of the blades, which in this case are rectangular in cross-section, are shown, the blades preferably being threaded in a detachable manner onto these reinforcements. Only one of the blades 4 is shown in dashed lines. Here there are three blades regularly spaced apart by 120° relative to each other about the axis of the rotor, but this number may be any number.

A shaft 5 for controlling the pitch of the blades rotates at the same time as the main shaft 2 and a mechanism (not shown) allows to slightly modify the angular position of this shaft 5 relative to the main axis 2 in order to adjust the pitch of the blades.

A direction control shaft 6 allows to orient the direction of the flow directly and over a 360° range, the rotation control of the shaft 6 causing a corresponding rotation of the behavior of each of the blades. When no change of direction is to be carried out, the shaft 6 remains in the same position. The drive device of the shaft 6, located above the rotor in a vertical axis propulsion application, is not shown here but can be realized for example with a cable control, with a gear train, with a belt, etc., driven by an actuator controlled by automaton or by manual control. The person skilled in the art will know how to choose the solution that is suitable, for example by taking inspiration from how outboard motors are oriented.

(In the case of a rotor used for energy recovery, the shaft 6 becomes the equivalent of the yaw axis and allows to orient the blades to follow the direction of the fluid).

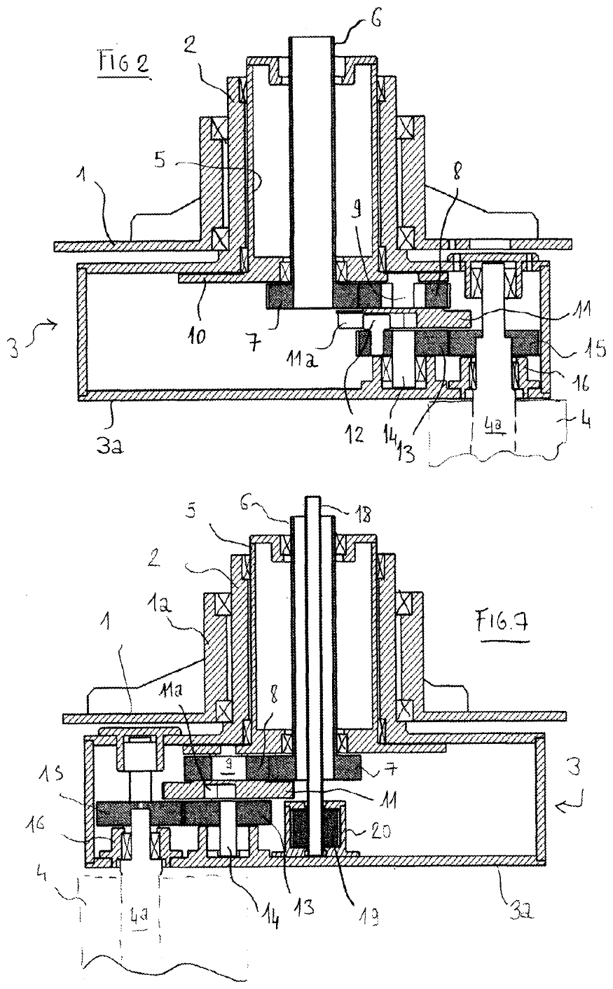

FIG. 2 shows the support 1 bearing the main shaft 2 of the rotor, which rotates the drum 3 to which it is rigidly connected.

The lower region of the control shaft 6 is rigidly connected to a pinion 7 of the appropriate type (straight, helical, herringbone, play compensation etc.). This pinion 7 is engaged with another pinion 8 which rotates about a pivot axis 9 mounted on a disc-shaped plate 10 constrained to rotate with the pitch control shaft 5. The shaft 5 and the plate 10 together form a pitch control cassette.

The pinion 8 is rigidly connected to an element 11, typically disc-shaped, wherein a rectilinear or curved slot 11a is formed. In the slot 11a, a pin or roller 12 rigidly connected to another pinion 13 can slide, being mounted eccentrically thereon. The pinion 13 pivots about a pivot axis 14 rigidly connected to the lower part of the drum 3. The pinion 13 meshes with a pinion 15 which is rigidly connected to the frame 4a of the corresponding blade, this reinforcement comprising an upper part, below the pinion 15, which constitutes its pivot in a part 16 forming a through-bearing rigidly connected to the base 3a of the drum 3.

The various rotary elements are mounted by using any suitable bearings, which are not described in detail but are shown in FIG. 2 in their standardized form.

It is specified here that the overall transmission ratio, dictated by the number of teeth of the various meshing pinions, is set to 1 so that the transmission returns to its original position after the rotor has rotated 360°.

In one embodiment, the pinions 7, 8, 13 and 15 have the same number of teeth, and this number is also advantageously a multiple of the number of blades on the rotor, which ensures an angular distribution of the transmission devices precisely corresponding to the distribution of the blades about the main axis.

It will be understood that by modifying the angular position of the control shaft 5 with a maximum amplitude relative to the main shaft 2 of the rotor, a misalignment between the respective axes of rotation of the pinions 8 and 13 is carried out, defined by their pivots 9, 14, in the circumferential direction.

When these axes are combined, then the pinion 8 drives the pinion 13, via the slot 11a and the pin 12, so that they move uniformly together.

Because all the pinions here have the same number of teeth, it will be understood that the absolute orientation of the pinion 15 remains constant during the rotation of the rotor, and therefore the corresponding blade retains a constant absolute orientation, the design being such that, in this situation, each of the blades has this same constant absolute orientation.

When the cassette 10 is turned by acting on the shaft 5, then the pivots 9 and 14 of the pinions 8 and 13 are offset from each other in the circumferential direction, which creates a periodic angular offset in the kinematics of the pinions 8 and 13 and, consequently, an oscillation of the blade 4 on either side of the aforementioned constant orientation during the rotation of the rotor.

Each blade is provided with the same transmission mechanism, and these mechanisms are configured to create a movement of the blades of the trochoidal type, the actual kinematics being determined by the shape of the slots 11a and by the degree of eccentricity between the pivot axes of the pinions 8 and 13. Thus, the greater this eccentricity, the greater the amplitude of oscillation of the blades.

Furthermore, when the direction control shaft 6 is rotated, the pinion 7 rotates and therefore causes the various transmission mechanisms to reorient the blades 4 with an angular gap corresponding exactly to the angular gap applied to the shaft 6.

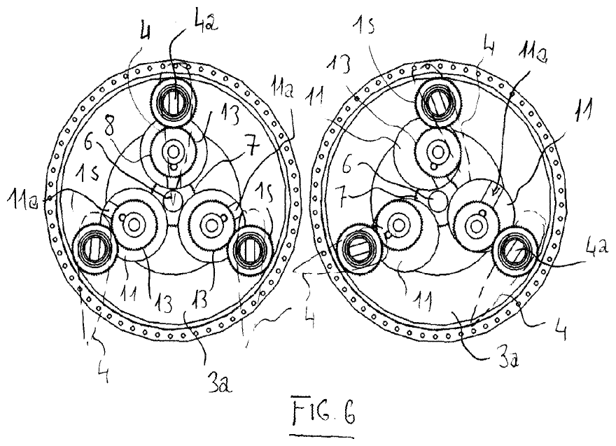

It will be noted that the slot/pin assembly creating the oscillation can comprise a play compensation mechanism, for example as described with reference to FIGS. 6A-6C of French patent application No. 2003668, the content of which is incorporated into this description by reference.

As already indicated, the slot 11a can be rectilinear or curved so that during design, the kinematics of the alternating movement of the blade can vary at will, relative to a generally sinusoidal evolution corresponding to the case where the slot is rectilinear.

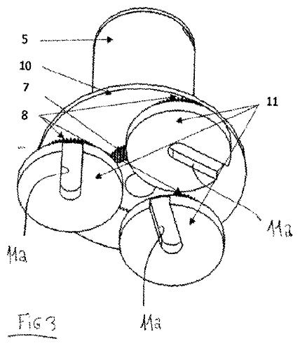

FIG. 3 shows the assembly forming a cassette for adjusting the maximum amplitude of oscillation of the blades. It shows the control shaft 5 rigidly connected to the plate 10 carrying the pivots of the pinions 8 and slot 11 elements 11a. It is also seen in this figure that the direction control pinion 7 is engaged with each of the pinions 8 constrained to rotate with the slot elements 11. Here, the slots are open outwardly to facilitate manufacturing and assembly, but they could be closed at both ends.

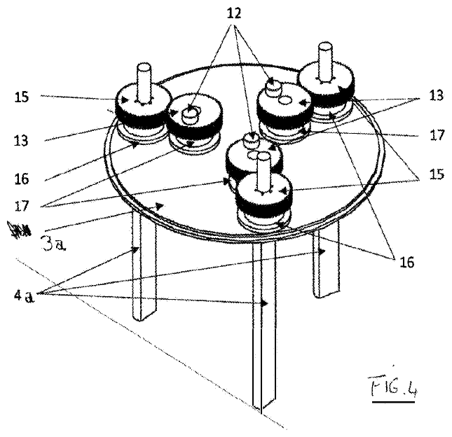

In FIG. 4, it can be seen that a lower plate 3a of the drum 3 bears the pinions 15 constrained to rotate with the frames 4a of the blades, as well as the pinions 13 supporting the pins or rollers 12, mounted in blind bearings 17 formed in the base 3a of the drum.

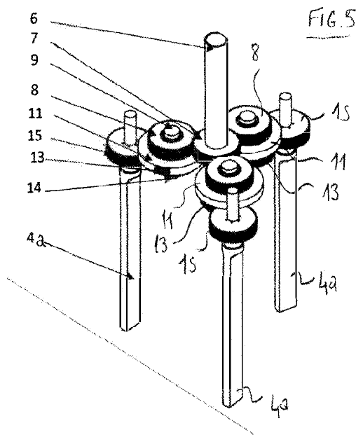

FIG. 5 shows the assembly of the kinematic chain described for each of the three blades, the various support elements not being shown.

On the left of FIG. 6, the position of the cassette 10 is such that the axes of rotation of the pinions 8 and 13 are aligned; consequently and as explained, the blades 4 remain oriented parallel to each other with a constant absolute orientation. The amplitude of oscillation is zero.

On the right of FIG. 6, the position of the cassette 10 is such that the axes of rotation of the pinions 8, 13 are offset circumferentially; consequently, the kinematics are such that the blades oscillate by describing a law of the trochoidal type during the rotation of the rotor. The higher the distance between the axes of rotation of the pinions 8, 13, the greater the amplitude of this oscillation.

Thus, a particularly reliable mechanism is obtained while being compact in particular in the axial direction (with only two planes for the gear trains) and radial (with the transfer of the eccentricity towards the interior relative to the mounting points of the blades) and a decreased weight. Furthermore, the mechanism for adjusting the oscillation amplitude of the blades (cassette 10) may be of a reduced diameter.

The invention described above can be the subject of numerous variants and modifications:
first, it is possible to combine the pinion 8 and the slotted disc 11 in a single piece, to further contribute to the dimensional reduction in the axial direction and to the weight reduction,
the pairs of pinions 7, 8 and 13, 15 in direct engagement can be replaced by pairs of rollers connected by respective notched chains or belts, as it has been observed that the resulting kinematic reversal is duplicative and therefore inoperative (only the elements 8, 11, 13 rotating in the opposite direction from what was described above),
the slot 11a/pin 12 cooperation can be inverted, the pin 12 being carried by the pinion 8 and the slotted disc 12 being constrained to rotate with the pinion 13 (or the slot being integrated into that pinion).

FIG. 7 shows another invention, applicable to the invention of FIGS. 1 to 6 as well as any other implementation of a rotor with directionally adjustable blades. This invention consists of being able to generate energy (an electric current, or even a pressurized hydraulic or pneumatic fluid) within the structure of the rotor itself, here inside the drum 3, without having to use collectors or other rotary joints, and therefore avoiding problems of any failure, wear and maintenance needs.

To this end, the rotor comprises, within the direction control shaft 5, a shaft 18 that is fixed relative to the base 1.

In the lower region of this shaft, a rotating element 19 is attached, intended to form the rotor of an electric generator, and preferably consisting of magnets.

The stator 20 of this same electrical generator consisting of one or more windings and is attached to the base 3a of the drum 3 so as to be concentric with the rotor 19.

It will be understood that during the rotation of the fluidic rotor and therefore of its drum 3 relative to the fixed shaft 18, the stator 20 of the electric motor rotates around its rotor, which generates at the winding(s) an electric current. The electrical energy thus formed in the rotating part of the fluidic rotor may, where appropriate, be stored in one or more batteries and supply any electrical member installed in said rotating part, such as sensor(s) or actuator(s).

In one embodiment, it may involve N rotary actuators respectively associated with the blades and intended to cause their pitch to vary as a function of the rotation of the fluidic rotor, the transmission as described with reference to FIGS. 1 to 6 no longer being necessary in such a case. The control signals of these actuators can be conveyed for example by radio transmission, with appropriate transmission/reception circuits, or by carrier currents, the rotor 19 of the electric motor in this case consisting of one or several windings conveying said signals.

According to another possibility, the electrical energy available within the rotor can be used to move the plate 10 of the maximum oscillation amplitude adjustment device, for example using an electric motor or one or more jacks.

In another embodiment, the rotor 19/stator 20 assembly forming an electric generator can be replaced (or supplemented) by a hydraulic or pneumatic pump, the consumers of the energy consisting of the pressurized fluid then being adapted accordingly.

Furthermore, independently of the transmission mechanisms described above and the generation of energy on-site as described above, a rotor structure comprising three coaxial shafts, namely an inner shaft 6 that is angularly movable to adjust the working direction of the rotor, an intermediate shaft 5 that is rotationally adjustable to control the angular movement of the plate of the adjustment device of the oscillation amplitude, and an outer shaft by which the rotor rotates relative to the fixed base 1, and where advantageously but optionally the outer shaft is rigidly connected to a hollow drum, is provided with a hollow drum housing said plate and the transmission devices and on a wall of which the blades are pivotably mounted. These three shafts can be arranged in different interior/middle/exterior arrangements.

1. A fluidic rotor, comprising a rotary structure mounted on a base and supporting a set of directionally adjustable blades capable of oscillating relative to the rotation of the rotary structure about a rotor axis, and a set of transmission devices between a central shaft of the rotor and each of the blades, capable of individually controlling the oscillations of said blades, each device comprising two pivoting elements having offset pivot axes, one of said elements having a slot and the other having a pin that engages the slot, wherein the two pivoting elements of each transmission device are intermediate elements of an individual transmission consisting of a set of elements engaged with each other between said central shaft and the blades.

2. The rotor according to claim 1, wherein said elements of a transmission device are toothed elements in direct engagement with one another.

3. The rotor according to claim 2, wherein the two pivot elements having offset pivot axes comprise a first intermediate element engaged with an axial element rigidly connected to the central shaft, and a second intermediate element engaged with an element constrained to rotate with a frame of the associated blade.

4. The rotor according to claim 1, wherein the pin of a transmission device is mounted directly in one of the intermediate elements.

5. The rotor according to claim 1, wherein the slot of a transmission device is provided in an element attached to a second one of the intermediate elements.

6. The rotor according to claim 1, wherein the slot of a transmission device is provided in a second one of the intermediate elements.

7. The rotor according to claim 1, further comprising a common device for adjusting the maximum amplitude of oscillation of the blades, this device comprising a plate able to rotate around the rotor axis and having pivots of the first or second intermediate elements of each of the transmissions, so as to vary the distance between the pivot axes of the first and second intermediate elements in the circumferential direction.

8. The rotor according to claim 7, further comprising an inner shaft constituting the central shaft of the rotor, angularly movable so as to cause a corresponding overall change in the pitch of the blades via the transmission devices, an intermediate shaft rotationally adjustable to control the angular displacement of the plate of the amplitude adjustment device, and an outer shaft belonging to the rotary structure of the rotor, all arranged concentrically about the axis of the rotor.

9. The rotor according to claim 8, wherein the outer shaft is rigidly connected to a hollow drum housing said plate and the transmission devices and to a wall of which the blades are pivotably mounted.

10. The rotor according to claim 1, wherein a fixed axial shaft and the rotary structure of the rotor carry inner and outer elements of a rotary machine, the outer element carried by the rotary structure being able to generate energy within said rotary structure under the effect of its rotation relative to the inner element carried by the central shaft.

11. The rotor according to claim 10, wherein the rotary machine belongs to a group comprising electric motors, electric generators and fluid pumps.

12. A rotary machine selected from a group comprising electric motors, electric generators and fluid pumps, the machine comprising a rotor according to claim 1.
